(19) United States
(12) Patent Application Publication
(10) Pub. No.: US 2023/0309531 A1
(43) Pub. Date: Oct. 5, 2023

(54) TACKLE MANAGEMENT SYSTEM

(71) Applicant: Joseph A. Kann, Racine, WI (US)

(72) Inventor: Joseph A. Kann, Racine, WI (US)

(21) Appl. No.: 18/295,187

(22) Filed: Apr. 3, 2023

Related U.S. Application Data
(60) Provisional application No. 63/327,500, filed on Apr. 5, 2022.

(51) Int. Cl. A01K 97/06; A01K 97/22

(52) U.S. Cl. CPC A01K 97/06; A01K 97/22

(57) ABSTRACT

A tackle management system includes a lid. The lid includes an annular ring for securing to a rim of a bucket, a support structure extending across the annular ring, a plurality of hanging lure holes in the annular ring, and at least one pedestal hole in the support structure extending across the annular ring. The bucket may have a bottom surface with at least one pedestal hole in the bottom surface of the bucket and wherein the at least one pedestal hole in the support structure of the lid is in alignment with the at least one pedestal hole in the bottom surface of the bucket. The lid may further include at least one secondary support structure extending outwardly from the support structure to the annular ring.

### RELATED APPLICATIONS

This application claims priority to U.S. provisional patent application no. 63/327,500, filed Apr. 5, 2022, hereby incorporated by reference in its entirety.

### FIELD OF THE INVENTION

The present invention relates to fishing. More particularly, but not exclusively, the present invention relates to a tackle management system.

### BACKGROUND

Although modern boats and fishing equipment provide anglers with numerous benefits and advantages, such conveniences can also create problems and limitations for anglers. Consider, for example, problems anglers may encounter when using a boat with a pedestal seat. Although pedestal seats may include various adjustments for comfort and allow anglers to have the advantage of an elevated position for fishing, there are challenges associated with keeping the space around the pedestal seat uncluttered and safe from sharp fishing hooks, tangled lines and tools which accumulate during the course of a day of fishing.

For example, when using a pedestal seat, an angler may place their favorite fishing lures and extra fishing rods loose on the floor around the pedestal seat which may create safety hazards and tangles due to the presence of sharp hooks and loose lines. In addition, the angler may not have tackle and tools within easy reach because such equipment is most often stored in other parts of the boat. Therefore, although pedestal seats are advantageous, they do not inherently help the fisherman safely and conveniently manage all the gear needed during a day of fishing.

### SUMMARY

Therefore, it is a primary object, feature, or advantage to improve over the state of the art.

It is a further object, feature, or advantage to provide a tackle management system which is compatible with pedestal seating.

It is a further object, feature, or advantage to provide a tackle management system which improves safety such as by providing a safe alternative to having sharp hooks loose in a boat.

It is a still further object, feature, or advantage to provide a tackle management system which has a reasonably simple construction.

It is a further object, feature, or advantage to provide a tackle management system which can be manufactured at a reasonable cost.

Another object, feature, or advantage is to provide a tackle management system which durable in construction.

Yet another object, feature, or advantage is to provide a tackle management system which places tackles and tools within easy reach of an angler.

One or more of these and/or other objects, features, or advantages will become apparent from the specification and claims that follow. No single embodiment need provide each and every object, feature, or advantage. Different embodiments may have different objects, features, or advantages. Therefore, the present invention is not to be limited to or by any objects, features, or advantages stated herein.

According to one aspect, a tackle management system is provided. The tackle management system includes a lid. The lid includes an annular ring for securing to a rim of a bucket, a support structure extending across the annular ring, a plurality of hanging lure holes in the annular ring, and at least one lid pedestal hole in the support structure extending across the annular ring. The bucket may have a bottom surface with at least one bucket pedestal hole in the bottom surface of the bucket and wherein the at least one lid pedestal hole in the support structure of the lid is in alignment with the at least one bucket pedestal hole in the bottom surface of the bucket. The lid may further include at least one secondary support structure extending outwardly from the support structure to the annular ring. The tackle management system may further include at least one spinner bait lure holder positioned on the at least one secondary support structure. The tackle management system may further include at least one pocket disposed in the lid. The at least one pocket may be disposed along the support structure. The tackle management system may further include at least one accessory loop positioned along the annular ring and/or positioned along the support structure. The tackle management system may further include a pedestal bushing for placement in one of the at least one lid pedestal hole. The at least one lid pedestal hole may include both a central pedestal hole and an offset pedestal hole. The tackle management system may further include a removable cup holder for placement in one of the central pedestal hole and the offset pedestal hole. The removable cup holder may further include at least one lighting element such as an LED.

According to another aspect, a system includes a bucket having a top opening and a bottom surface opposite the top opening and a lid for fitting over the top opening. The lid may include an annular ring for securing to a rim of a bucket, a support structure extending across the annular ring, a plurality of hanging lure holes in the annular ring, and at least one lid pedestal hole in the support structure extending across the annular ring. The bucket may further include at least one bucket pedestal hole in the bottom surface. The at least one lid pedestal hole in the support structure and the at least one bucket pedestal hole in the bottom surface may be vertically aligned to receive a shaft of a pedestal seat. The at least one lid pedestal hole in the support structure may include both of a center lid pedestal hole and an offset lid pedestal hole. The system may further include a lid pedestal bushing. The lid may further include at least one secondary support structure extending outwardly from the support structure to the annular ring. The system may further include at least one spinner bait lure holder positioned on the at least one secondary support structure. The system may further include at least one pocket disposed in the lid and the pocket may be disposed along the support structure. The system may further include at least one accessory loop positioned along the annular ring and/or at least one accessory loop positioned along the support structure. The system may further include a removable cup holder for placing in one of the at least one lid pedestal hole in the lid. The removable cup holder may include at least one lighting element. The lid may be formed of plastic. The bucket may be formed of plastic. The system may further include a pedestal seat having a central shaft and a plurality of lures for hanging in the lure holders.

According to another aspect, a tackle management system includes a lid comprising shaped for securing to a rim of a bucket, a support structure extending across the lid, a plurality of hanging lure holes in a periphery of the lid, and at least one lid pedestal hole in the support structure extending across the lid. The bucket may have a bottom surface with at least one bucket pedestal hole in the bottom surface of the bucket and wherein the at least one lid pedestal hole in the support structure of the lid is in alignment with the at least one bucket pedestal hole in the bottom surface of the bucket. The lid may include at least one secondary support structure extending outwardly from the support structure. There may be at least one spinner bait lure holder positioned on the at least one secondary support structure. There may be at least one pocket disposed in the lid which may be disposed along the support structure, at least one accessory loop positioned along lid, and/or at least one accessory loop positioned along the support structure. The system may further include a pedestal bushing for placement in one of the at least one lid pedestal hole. The at least one lid pedestal hole may include a central lid pedestal hole and an offset lid pedestal hole. The system may further include a removable cup holder for placing in one of the central lid pedestal hole and the offset lid pedestal hole and the removable cup holder may include at least one lighting element.

According to another aspect, a system includes a bucket having a top opening and a bottom surface opposite the top opening, a lid for fitting over the top opening and configured for securing to a rim of a bucket, a support structure extending across the lid, a plurality of hanging lure holes at an outer periphery of the lid, and at least one lid pedestal hole in the support structure extending across the lid. The bucket may further include at least one bucket pedestal hole in the bottom surface.

### BRIEF DESCRIPTION OF THE DRAWINGS

Illustrated embodiments of the disclosure are described in detail below with reference to the attached drawing figures, which are incorporated by reference herein.

FIG. 1 illustrates one example of a tackle management system.

FIG. 2 illustrates the tackle management system with examples of hanging lures and a spinner bait hanging lure.

FIG. 3 illustrates the tackle management system with a pedestal seat installed.

FIG. 4 illustrates the tackle management system with examples of different accessories which may be used with or organized by the bucket lid.

FIG. 5 illustrates the tackle management system with a cup holder and a pedestal bushing.

FIG. 6 illustrates the tackle management system with a pedestal seat installed in a center pedestal hole.

FIG. 7 illustrates the tackle management system with a pedestal seat installed in an offset from center pedestal hole.

FIG. 8 illustrates the tackle management system with a pedestal seat installed and a pedestal bushing around a shaft of the pedestal sheet.

FIG. 9 illustrates the tackle management system with an illuminated cupholder.

### DETAILED DESCRIPTION

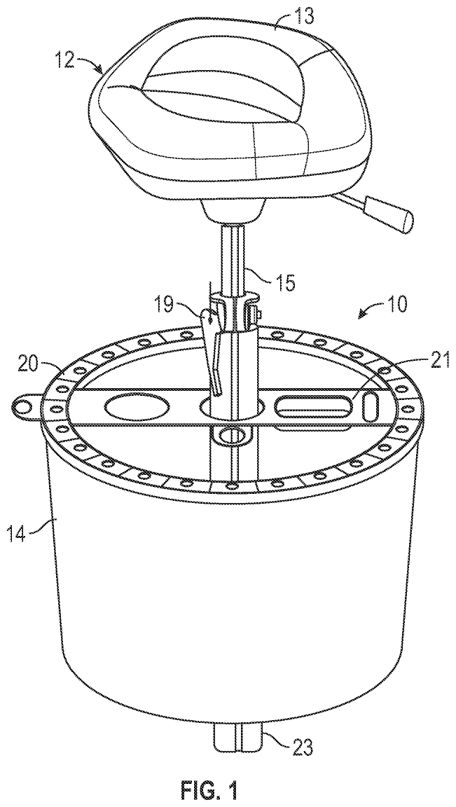

FIG. 1 illustrates one example of a tackle management system 10 for use with a pedestal seat 12. The pedestal seat 12 may have a seat cushion 13 and may include an adjustment for adjusting position and a height adjustment 19 for adjusting height of the pedestal seat 12. A central shaft 23 which is generally vertical is shown which may have a telescoping portion 15 for height adjustment.

The tackle management system 10 may include a base which may take the form of a bucket 14. The bucket 14 may be a plastic bucket constructed by modifying a conventional 5 gallon bucket. The tackle management system 10 may further include a bucket lid 20 which fits and/or is secured to the bucket 14.

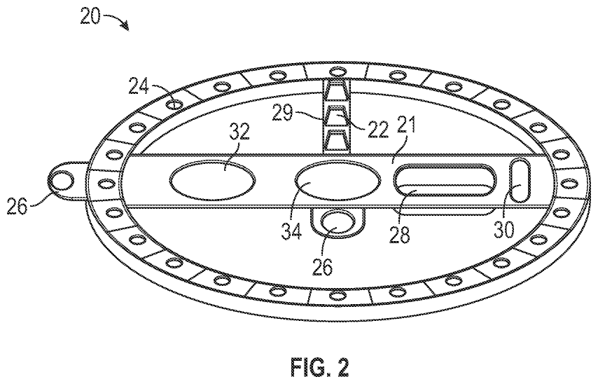

FIG. 2 further illustrates one example of the bucket lid 20. As shown in FIG. 2, the bucket lid 20 is generally circular in shape so that the bucket lid 20 may be supported on the rim of the bucket. However, it is contemplated that the bucket and thus the bucket lid 20 need not be perfectly circular but may be of other shapes such as associated with different buckets. Where the shape of the bucket lid 20 is described as a ring or annular ring, it is to be understood that the ring need not be circular. A plurality of hanging lure holes 24 are shown which are positioned around the bucket lid. In operation, the hooks of fishing lures may be placed within the hanging lure holes 24. Thus, the hooks of the fishing lures are not exposed in a manner which is dangerous while the fishing lures remain conveniently within reach of an angler.

The bucket lid 20 as shown may also include one or more spinner bait lure holders 22. The spinner bait lure holders may be constructed in various ways such as with compression catches or clamps to hold the spinner bait lure holders in a manner such as disclosed in U.S. Pat. No. 6,860,059. U.S. Pat. Nos. 6,860,059 and 7,299,584. The spinner bait lure holders may otherwise be notched upright posts or may be alternative structures appropriate for holding spinner bait lures.

In addition to providing for organizing lures in a convenient and safe fashion, the bucket lid 20 may also provide for organizing other tools and accessories. For example, the bucket lid 20 may include one or more accessory loops 26. The one or more accessory loops 26 may be used in various ways. The one or more accessory loops 26 may have different sizes or shapes depending on the types of accessories to be used with the accessory loops 26. The one or more accessory loops may be positioned along the annular ring or along the support structure or elsewhere.

A cell phone pocket 28 may also be present, which has an opening and a downwardly extending pocket of sufficient size to hold mobile phones such as Apple iPhones™, Samsung Galaxy™, phones or other common mobile phones. One or more fishing tool holder slots 30 may also be present which may be sized and shaped so as to hold common fishing tools such as needle nose pliers or other types of fishing tools.

The bucket lid 20 has a support structure 21 which extends across a diameter of the bucket lid. There may be ribs or other reinforcing structure (not shown) present on the underside of the support structure 21. A secondary support structure 29 extends radially inward from an annular ring of the bucket lid to the support structure 21. Having one or more secondary support structures 29 assists in providing sufficient support while also providing additional surface area for openings or structures to assist in organizing lures, tools, and/or accessories In addition, having open areas provides space for lures or other tools to extend downwardly below the bucket lid and within the bucket itself. It is to be understood that there may be more than one secondary support structures 29 present.

In the support structure 21 there are pedestal holes (referenced herein as lid pedestal holes to distinguish form pedestal holes in the bucket) such as a center lid pedestal hole 34 and an offset lid pedestal hole 32. The central shaft of the pedestal seat may extend through one of the lid pedestal holes. Having more than one lid pedestal hole present provides more flexibility for the angler in that they may choose which lid pedestal hole to use based on their preference.

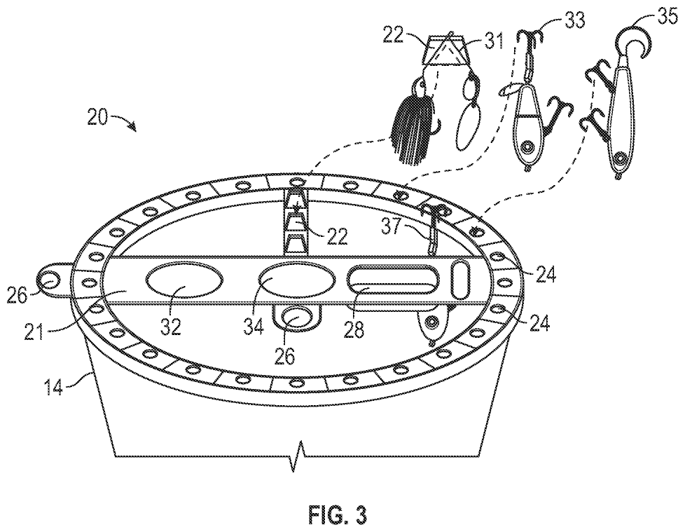

FIG. 3 illustrates the bucket lid 20 showing an example of a spinner bait lure 31 which may be positioned in a spinner bait lure holder 22 and examples of hanging lures 33, 35, 37. Hanging lure 37 is shown hanging downwardly into the bucket thus the angler is protected from the hooks of the lure.

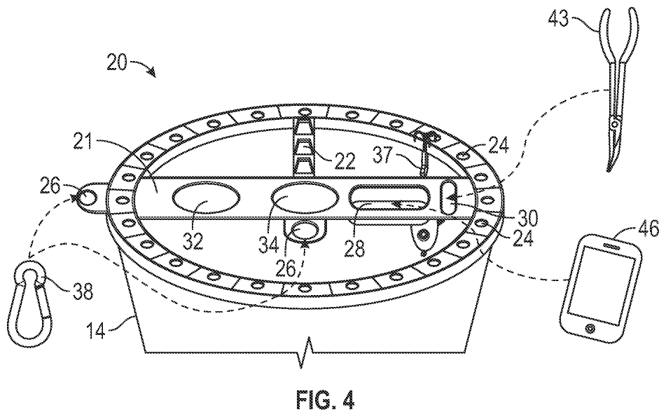

FIG. 4 illustrates the bucket lid 20 with examples of different accessories which may be used with or organized by the bucket lid 20. A mobile phone 46 is shown which may be placed within the cell phone pocket 28. A set of needle nose pliers 43 may be inserted in the fishing tool holder slot 30. A clip 38 may be clipped to the accessory loop 26. Thus, the accessory loops may be used for line clippers, hand towels, or otherwise. Therefore, it should be understood that various features of the tackle management system allow for a variety of common fishing accessories and tools to be stored, organized, and/or maintained within convenient reach of the angler.

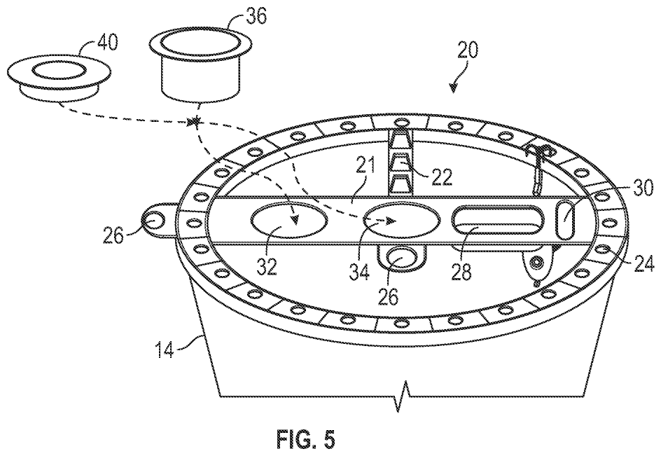

FIG. 5 illustrates the bucket lid 20 and a pedestal bushing 40. The pedestal bushing 40 may be placed in the center lid pedestal hole 34 or alternatively in the offset lid pedestal hole 32 to protect the bucket lid 20 from the central shaft of the pedestal seat and in order to better accommodate different sizes of central shafts. A cup holder 36 is also shown which may be placed in the offset lid pedestal hole 32 or alternatively the center lid pedestal hole 34.

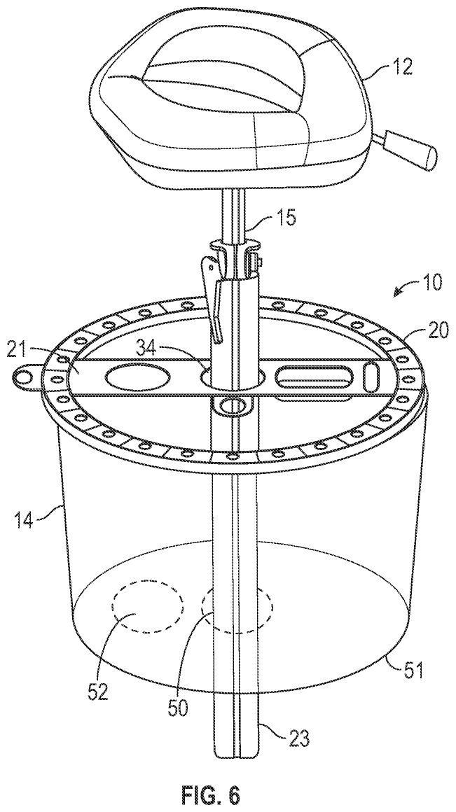

FIG. 6 illustrates the pedestal seat 12 with the central shaft 23 of the pedestal seat 12 inserted through the center lid pedestal hole 34 and further through the center lid pedestal hole 50 of a bottom surface 51 of the bucket 14. An offset bucket pedestal hole 52 of the bottom surface 51 of the bucket 14 is also shown. The pedestal holes of the lid and the pedestal holes of the bottom surface 51 of the bucket are in vertical alignment.

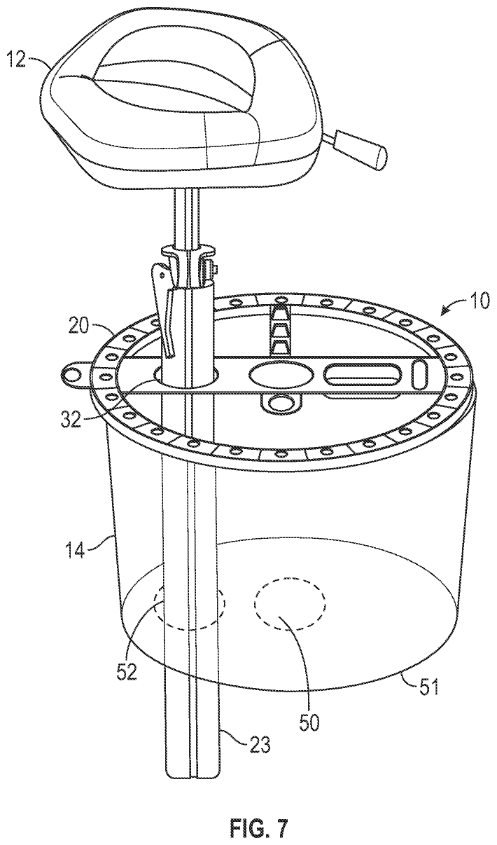

FIG. 7 further illustrates the pedestal seat 12 with the central shaft 23 of the pedestal seat 12 inserted through the offset bucket pedestal hole 52 of the bottom surface 51 of the bucket. The pedestal holes of the lid and the pedestal holes of the bottom surface 51 of the bucket are in vertical alignment.

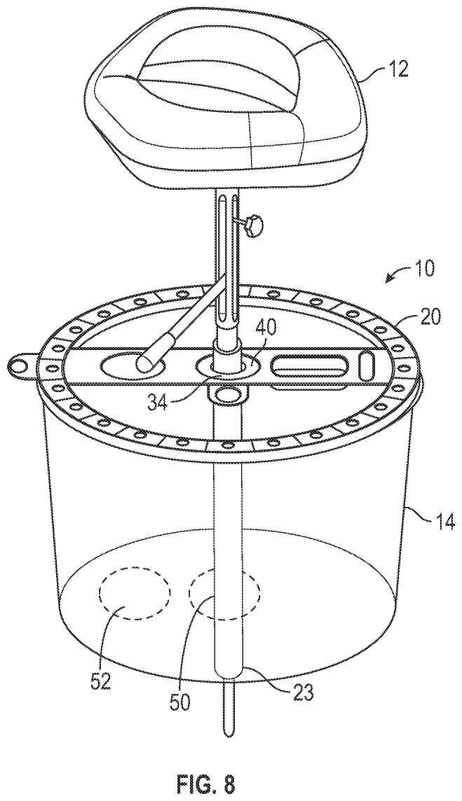

FIG. 8 illustrates the pedestal seat 12 with a central shaft 23 of a diameter significantly smaller than the diameter of the center lid pedestal hole 34. The pedestal bushing 40 is shown inserted in the center lid pedestal hole 34 to allow for a tighter and more stable fit of the tackle management system 10.

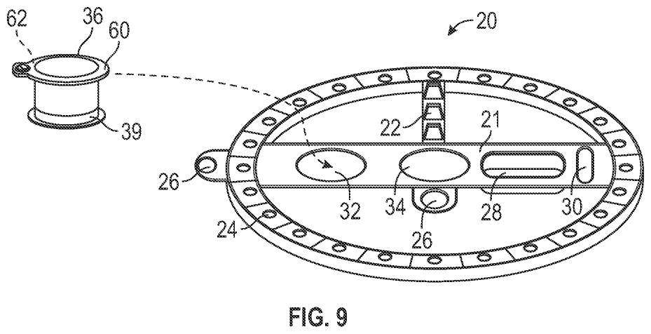

FIG. 9 illustrates the bucket lid 20 along with a cup holder 36. The cup holder 36 may have a rim 60 formed from a transparent or translucent material and one or more LEDs or other lighting sources 62 may be positioned in the rim 60 or otherwise in optical communication with the rim such that the rim may be illuminated to assist the angular in placing their beverage in the cup holder 36. The cup holder 36 may also include its own power source such as a removable battery. Where a removable battery is present, the cup holder 36 may have a battery compartment 39 for holding the battery.

The tackle management system 10 may be manufactured in any number of different ways. For example, the bucket lid 20 may be manufactured using a plastic material. The bucket lid 20 may be manufactured through an additive manufacturing process, a subtractive manufacturing process, polymer casting, vacuum forming, injection molding, or other types of manufacturing processes. Alternatively, the bucket lid may be made from other types of materials such as metal and may be machined or otherwise manufactured.

The bucket itself may be formed by modifying a pre-existing bucket such as a standard 5-gallon bucket. In such an instance, the handle may be removed or may be present. The bucket may be modified by drilling, cutting, or otherwise creating one or more holes in the bottom of the bucket. Instead of a pre-existing bucket it is also contemplated that the bucket may be manufactured through any number of appropriate methods to include one or more holes in the bottom or without a bottom. It should be understood that the bucket need not have a circular opening at top but may be otherwise shaped. In addition, although plastic is a lightweight, durable material which can permit reasonable costs of manufacturing, it is contemplated that other materials may be used including metal, wood, or other suitable materials.

In some embodiments it is contemplated that the bucket lid 20 may be separately sold and an angular may be instructed regarding how to modify an existing bucket such as by forming one or more holes in the bottom of the bucket. In some embodiments, a second bushing may be provided for the bottom of the bucket. In some embodiments, the bucket lid 20 may be configured or customized for use with a particular set of lures or a particular set of tools. Such lures or tools may be sold with the bucket lid as a set. In some embodiments, the bucket lid may be accompanied by other accessories such as a lure storage container for storing the same number of lures as may be held on the bucket lid. In some embodiments, multiple pedestal bushings of different sizes may be provided for accommodating pedestal seats with different sizes of shafts.

The invention is not to be limited to the particular embodiments described herein. In particular, the invention contemplates numerous variations in sizes, shapes, and dimensions. This includes the size and shape of a bucket, the size and shape of the lid, the size, shape, and position of the support structure and the secondary support structure. This further includes the size, number, and placement of openings in the lid for hanging lures, the pedestal openings, the accessories, and other variations. The foregoing description has been presented for purposes of illustration and description. It is not intended to be an exhaustive list or limit any of the invention to the precise forms disclosed. It is contemplated that other alternatives or exemplary aspects are considered included in the invention. The description is merely examples of embodiments, processes or methods of the invention. It is understood that any other modifications, substitutions, and/or additions can be made, which are within the intended spirit and scope of the invention.

What is claimed is:

1. A tackle management system comprising:
a lid comprising:
an annular ring for securing to a rim of a bucket;
a support structure extending across the annular ring;
a plurality of hanging lure holes in the annular ring; and
at least one lid pedestal hole in the support structure extending across the annular ring.

2. The tackle management system of claim 1 wherein the bucket has a bottom surface with at least one bucket pedestal hole in the bottom surface of the bucket and wherein the at least one lid pedestal hole in the support structure of the lid is in alignment with the at least one bucket pedestal hole in the bottom surface of the bucket.

3. The tackle management system of claim 1 wherein the lid further comprises at least one secondary support structure extending outwardly from the support structure to the annular ring.

4. The tackle management system of claim 3 further comprising at least one spinner bait lure holder positioned on the at least one secondary support structure.

5. The tackle management system of claim 1 further comprising at least one pocket disposed in the lid.

6. The tackle management system of claim 5 wherein the at least one pocket is disposed along the support structure.

7. The tackle management system of claim 1 further comprising at least one accessory loop positioned along the annular ring.

8. The tackle management system of claim 1 further comprising at least one accessory loop positioned along the support structure.

9. The tackle management system of claim 1 further comprising a pedestal bushing for placement in one of the at least one lid pedestal hole.

10. The tackle management system of claim 1 wherein the at least one lid pedestal hole includes a central lid pedestal hole and an offset lid pedestal hole.

11. The tackle management system of claim 10 further comprising a removable cup holder for placing in one of the central lid pedestal hole and the offset lid pedestal hole.

12. The tackle management system of claim 11 wherein the removable cup holder comprises at least one lighting element.

13. A system comprising:
a bucket having a top opening and a bottom surface opposite the top opening; and
a lid for fitting over the top opening, the lid comprising:
an annular ring for securing to a rim of the bucket;
a support structure extending across the annular ring;
a plurality of hanging lure holes in the annular ring; and
at least one lid pedestal hole in the support structure extending across the annular ring;
wherein the bucket further comprises at least one bucket pedestal hole in the bottom surface.

14. The system of claim 13 wherein the at least one lid pedestal hole in the support structure and the at least one bucket pedestal hole in the bottom surface are vertically aligned to receive a shaft of a pedestal seat.

15. The system of claim 13 wherein the at least one lid pedestal hole in the support structure includes a center lid pedestal hole and an offset lid pedestal hole.

16. The system of claim 13 further comprising a pedestal bushing.

17. The system of claim 13 wherein the lid further comprises at least one secondary support structure extending outwardly from the support structure to the annular ring and at least one spinner bait lure holder positioned on the at least one secondary support structure.

18. A system comprising:
a bucket having a top opening and a bottom surface opposite the top opening;
a lid for fitting over the top opening and configured for securing to a rim of a bucket;
a support structure extending across the lid;
a plurality of hanging lure holes at an outer periphery of the lid; and
at least one lid pedestal hole in the support structure extending across the lid;
wherein the bucket further comprises at least one bucket pedestal hole in the bottom surface.

19. The system of claim 18 wherein the at least one lid pedestal hole comprises a center lid pedestal hole and an offset lid pedestal hole.

20. The tackle management system of claim 19 wherein the lid further comprises at least one secondary support structure extending outwardly from the support structure to the annular ring.
